(19) United States
(12) Patent Application Publication
(10) Pub. No.: US 2011/0072940 A1
(43) Pub. Date: Mar. 31, 2011

(54) Wrench having detachable wrench head

(76) Inventor: Chih-Min Chang, Changhua Hsien (TW)

(21) Appl. No.: 12/591,806

(22) Filed: Dec. 2, 2009

(30) Foreign Application Priority Data
Sep. 29, 2009 (TW) 98217983

(51) Int. Cl. B25B 13/02; B25B 13/58

(52) U.S. Cl. 81/125.1; 81/180.1

(57) ABSTRACT

A wrench includes a handle having an end surface defining a socket and an outer periphery defining a hole in communication with the socket, a wrench head having a body portion inserted in the socket of the handle, and a recess aligned with the hole of the handle, and a fastener detachably fastened to the hole of the handle and having a distal end inserted in the recess of the wrench head. Accordingly, as long as the fastener is removed from the hole of the handle, the wrench head can be drawn out from the socket of the handle for maintenance or replacement.

### BACKGROUND OF THE INVENTION

1. Field of the Invention

The present invention relates generally to a wrench, and more specifically to a wrench having at least one detachable wrench head for driving a nut or bolt head.

2. Description of the Related Art

FIG. 1 shows a conventional wrench 10 comprising a handle 12 and two wrench heads 14. The handle 12 has a socket 122 through two ends thereof for insertion of the wrench heads 14, and two pairs of protrusions 124. As shown in FIG. 2, each pair of the protrusions 124 are respectively projected out from the inner periphery walls of the top and bottom sides of the handle 12 for engagement with holes 142 of the wrench heads 14, thereby enabling the wrench heads 14 to be mounted with the handle 12. According to this design, the wrench heads 14 are undetachable from the handle 12 after they are mounted with the handle 12 by means of the engagement between the protrusions 124 of the handle 12 and the holes 142 of the wrench heads 14. Under this circumstance, the wrench 10 will become functionless and discardable if one of the wrench heads 14 is damaged, resulting in waste of the product.

### SUMMARY OF THE INVENTION

It is one objective of the present invention to provide a wrench having a detachable wrench head for facilitating maintenance and replacement of the damaged wrench head.

To achieve this objective of the present invention, the wrench comprises a handle having an end surface defining a socket and an outer periphery defining a hole in communication with the socket, a wrench head having a head portion and a body portion integrally extending from the head portion and inserted in the socket of the handle and provided with a recess aligned with the hole of the handle, and a fastener detachably fastened to the hole of the handle and having a distal end inserted in the recess of the wrench head.

By means of removing the fastener from the hole of the handle, the damaged wrench head can be detached from the socket of the handle for maintenance or replacement, promoting a decrease in waste of the product.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of a wrench according to a prior art;

FIG. 2 is a partial cutaway view of the wrench according to the prior art;

FIG. 3 is a perspective view of a wrench according to a first preferred embodiment of the present invention;

FIG. 4 is an exploded view of the wrench according to the first preferred embodiment of the present invention;

FIG. 5 is a partial cutaway view of the wrench according to the first preferred embodiment of the present invention; and

FIG. 6 is a perspective view of the wrench according to a second preferred embodiment of the present invention.

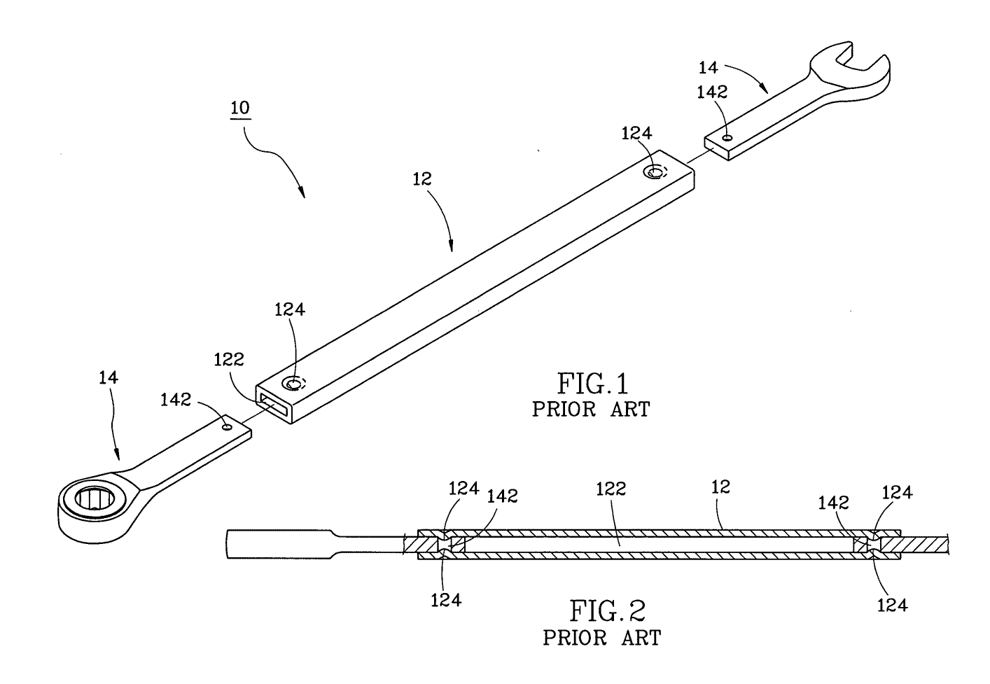

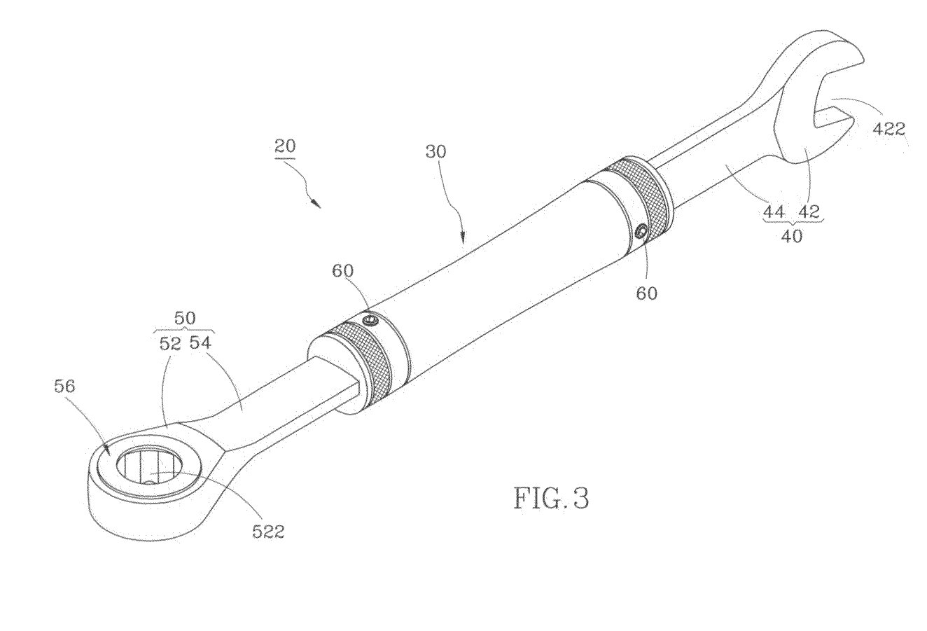

### DETAILED DESCRIPTION OF THE INVENTION

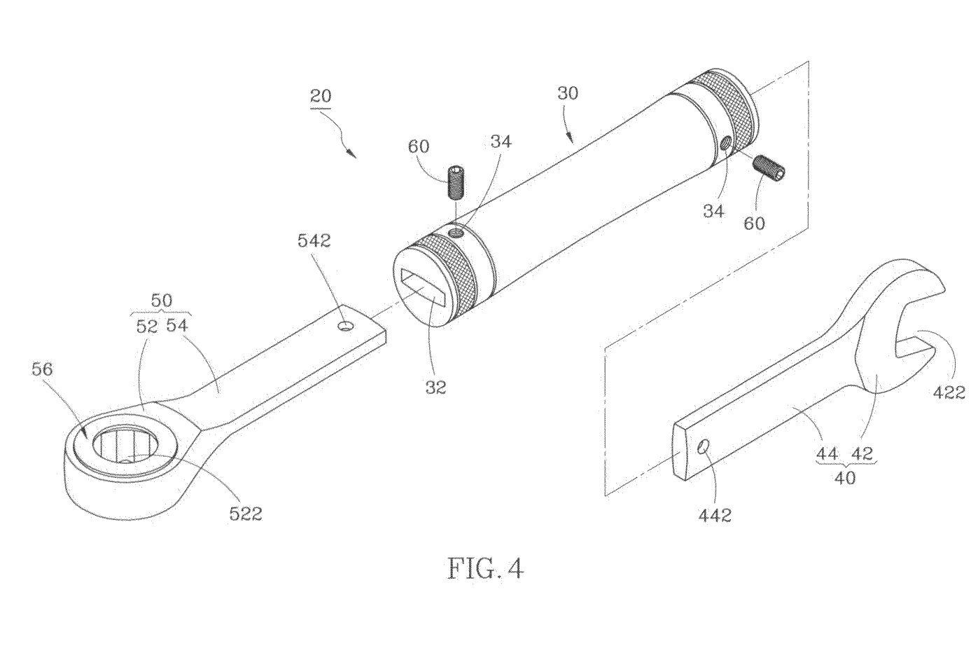

As shown in FIGS. 3 and 4, a wrench 20 in accordance with a first preferred embodiment of the present invention comprises a handle 30, a first wrench head 40, a second wrench head 50, and two fasteners 60.

The handle 30 is solid, having two end surfaces each defining a socket 32, and an outer periphery defining two holes 34, each of which communicates with one of the sockets 32. A line defined between the holes 34 of the handle 30 isn't parallel to an axial direction of the handle 30.

The first wrench head 40 includes a first head portion 42 having a U-shaped opening 422 for engagement with a nut or bolt head, and a first body portion 44 integrally extending from the first head portion 42 and inserted into one of the sockets 32 of the handle 30 and having a first recess 442 at a distal end thereof aligned with one of the holes 34 of the handle 30.

The second wrench head 50 includes a second head portion 52 having a circular mounting hole 522 for installation of a ratchet wheel 56, and a second body portion 54 integrally extending from the second head portion 52 and inserted into the other of the sockets 32 of the handle 30 and having a second recess 542 at a distal end thereof aligned with the other of the holes 34 of the handle 30.

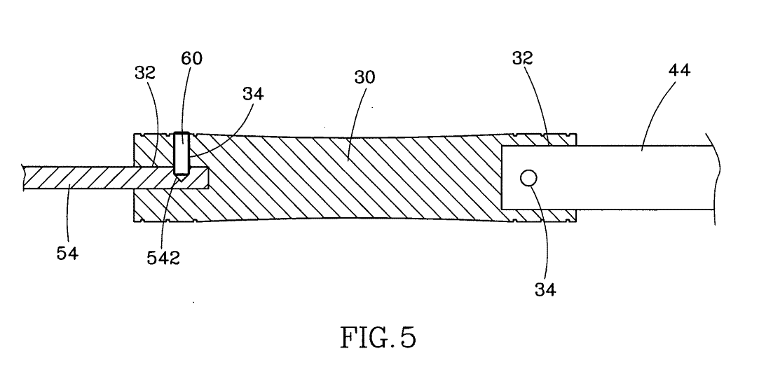

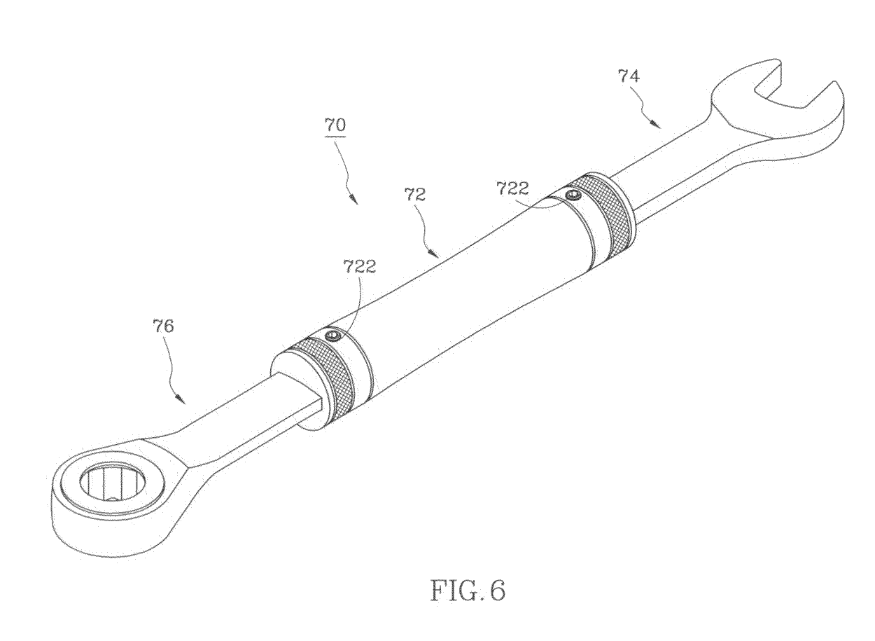

As shown in FIG. 5, each of the fasteners 60 is embodied as a screw so as to be screwed to one of the holes 34 of the handle 30, and provided with a distal end inserted into one of the first recess 442 of the first wrench head 40 and the second recess 542 of the second wrench head 50 for fastening the first and second wrench heads 40 and 50 to the handle 30.

When the wrench 20 has been used for a long time, the first head portion 42 of the first wrench head 40 or the second head portion 52 of the second wrench head 50 may suffer a damage severe enough to result in that the nut or bolt head can't be grasped tightly by the first head portion 42 of the first wrench head 40 or the ratchet wheel 56 can't be assembled securely with the second head portion 52 of the second wrench head 50. Under this situation, a user can use a screwdriver to remove the fastener 60 associated with the damaged wrench head in order to draw out the damaged wrench head from the socket 32 of the handle 30 for maintenance or replacement. Thereafter, the user can insert a repaired or new wrench head into the socket 32 of the handle 30 and then tighten the fastener 60 again to complete the replacement work, thereby attaining the purpose of reducing the waste of the product.

The wrench of the present invention can be made with various kinds of design on the basis of the spirit of the present invention. As shown in FIG. 6, a wrench 70 in accordance with a second preferred embodiment of the present invention is substantially similar to the aforesaid first embodiment with the exception of the positions of the holes 722 of the handle 72. The line defined between the holes 722 of the handle 72 is parallel to the axial direction of the handle 72 such that the first and second wrench heads 74 and 76 are located on the same imaginary plane after fastened to the handle 72.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wrench comprising:
a handle having an end surface defining a socket, and an outer periphery defining a hole in communication with the socket;
a wrench head having a head portion and a body portion integrally extending from the head portion and inserted in the socket of the handle, the body portion of the wrench head being provided with a recess aligned with the hole of the handle; and
a fastener detachably fastened to the hole of the handle and having a distal end inserted in the recess of the wrench head.

2. The wrench as claimed in claim 1, wherein the handle is solid.

3. A wrench comprising:
a handle having a first end surface defining a first socket, a second end surface defining a second socket, and an outer periphery having a first hole in communication with the first socket, and a second hole in communication with the second socket;
a first wrench head having a head portion and a body portion integrally extending from the head portion and inserted in the first socket of the handle, the body portion of the first wrench head being provided with a recess aligned with the first hole of the handle;
a second wrench head having a head portion and a body portion integrally extending from the head portion of the second wrench head and inserted in the second socket of the handle, the body portion of the second wrench head being provided with a recess aligned with the second hole of the handle;
a first fastener detachably fastened to the first hole of the handle and having a distal end inserted in the recess of the body portion of the first wrench head, and
a second fastener detachably fastened to the second hole of the handle and having a distal end inserted in the recess of the body portion of the second wrench head.

4. The wrench as claimed in claim 3, wherein a line defined between the first and second holes of the handle is parallel to an axial direction of the handle.

5. The wrench as claimed in claim 3, wherein a line defined between the first and second holes of the handle isn't parallel to an axial direction of the handle.

6. The wrench as claimed in claim 3, wherein the handle is solid.
